(19) United States
(12) Patent Application Publication
(10) Pub. No.: US 2006/0141190 A1
(43) Pub. Date: Jun. 29, 2006

(54) Hollow body produced from a planar textile structure, especially for equipping vehicles

(76) Inventor: Holger Sieben, Bocholt (DE)

Correspondence Address: FRIEDRICH KUEFFNER, 317 MADISON AVENUE, SUITE 910, NEW YORK, NY, 10017, US

(21) Appl. No.: 10/541,606

(22) PCT Filed: Dec. 27, 2003
(86) PCT No.: PCT/EP03/14924

§ 371 Date: Feb. 21, 2006

(30) Foreign Application Priority Data
Jan. 7, 2003 (DE) 103-00-121.2

(51) Int. Cl. B60R 21/16

(52) U.S. Cl. 428/36.1

(57) ABSTRACT

The invention relates to hollow bodies from a planar textile structure that are either open or closed. In order to allow for production of molded parts (20) of this type with maximum mold depth, at least one mold-parting line (15) is provided in the mold wall (22), which extends at least over a partial height of the lateral mold wall (22), thereby producing in the planar textile structure elastic lines between the inner parting line ends (19). The mold-parting lines (15) and the elastic lines define at least two mold segments (11, 12) from which the molded part (20) is produced by folding movements, the elastic line serving as the folding axis. The molded part is produced from the planar structure in the unfolded position of the mold segments (11, 12), said mold segments (11, 12) remaining interlinked by the elastic lines. The finished molded part (20) is obtained by folding the mold segments (11, 12) towards each other. In the folded position of the molded part, the mold-parting lines (15) touch each other.

The invention pertains to a molded article of the type indicated in the introductory clause of Claim 1. The flat textile products used for this purpose consist of nonwoven material or needled felt. The molded articles are produced in a press, consisting of an upper and a lower die. The flat textile product is laid between the two dies, and these are then brought together. The flat textile product is treated with a binder, which binds the textile fibers together. For this purpose, the press is heated or cooled as required. After the pressing step, the molded article retains the shape impressed upon it by the dies.

Such molded articles are used to fit out motor vehicles. The production of shell-shaped molded articles of considerable depth is difficult and expensive in terms of material. For example, the depth of the shell-shaped product has been limited in the past by the deep-drawability of the flat textile product. The flat product will tear if the deformation exceeds a certain depth. A large amount of material must be used, because, when the article to be press-molded is very deep, the flat product must have a high input weight. This is why the known molded articles with deep shells have always had a relatively high unit weight.

The invention is based on the task of developing a satisfactory molded article of the shell type as indicated in the introductory clause of Claim 1, which, even though of considerable depth, is characterized by a surprisingly low input weight, while the desired minimum wall thickness is also maintained. This is achieved by means of the measures indicated in the characterizing clause of Claim 1, to which the following special meaning attaches.

The invention uses two parting lines to divide the molded article into at least two molded segments; the molded segments are connected to each other by a linear bending line in the flat textile product. This bending line functions as a fold axis, around which the molded segments can move with respect to each other between a folded-out position and folded-in position. It is thus the width of one of the molded segments which then determines the depth to which the flat textile product is molded in the press dies, and this width is much smaller than the shell depth of the finished molded article. The finished deep-shell molded article is not obtained until after the molded segments have been folded together. Then the two parting lines come into contact with each other. The depth of the shell is no longer determined by the depth to which the flat textile product can be molded and can thus be as deep as desired. The bottom of the shell and the side walls can take any desired form. All this is possible, because the shell depth of the finished molded article no longer determines the direction in which the flat textile product must be drawn. The flat product can be deep-drawn either diagonally or transversely woth respect to the course of the joints. With respect to the finished product, the flat product is therefore deep-drawn in a completely different direction, that is, in a much more favorable one: the cross section of one of the molded segments determines the molded depth.

Additional measures and advantages of the invention can be derived from the subclaims, from the following description, and from the drawings. The drawings illustrate the invention on the basis of several exemplary embodiments:

FIG. 1 shows a schematic, longitudinal cross section through a part of a vehicle body, in which a molded article according to the invention has been inserted;

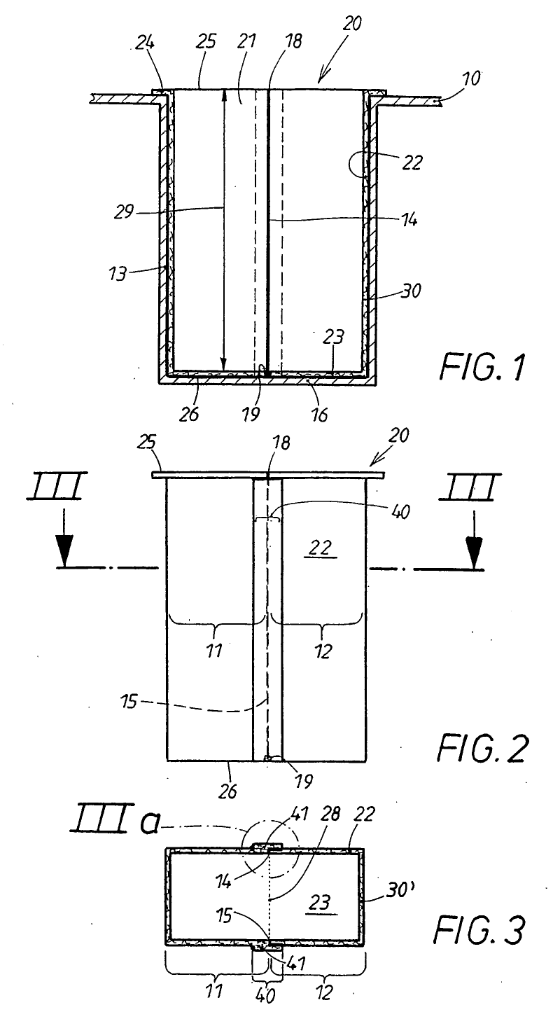

FIG. 2 shows a side view of the molded article used in FIG. 1 before it has been installed in the vehicle body;

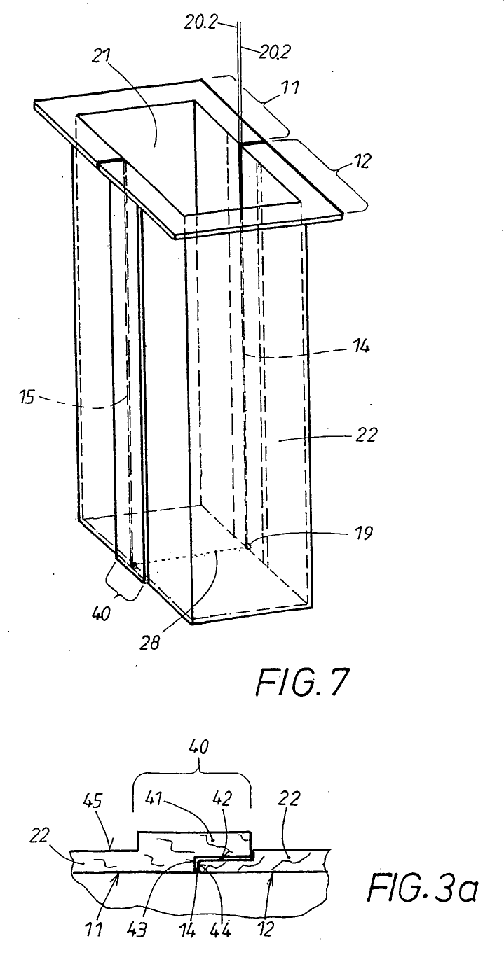

FIG. 3 shows a cross section through the molded article of FIG. 2 along line III-III in that figure;

FIG. 3a shows an enlarged view of the detail marked IIIa in FIG. 3;

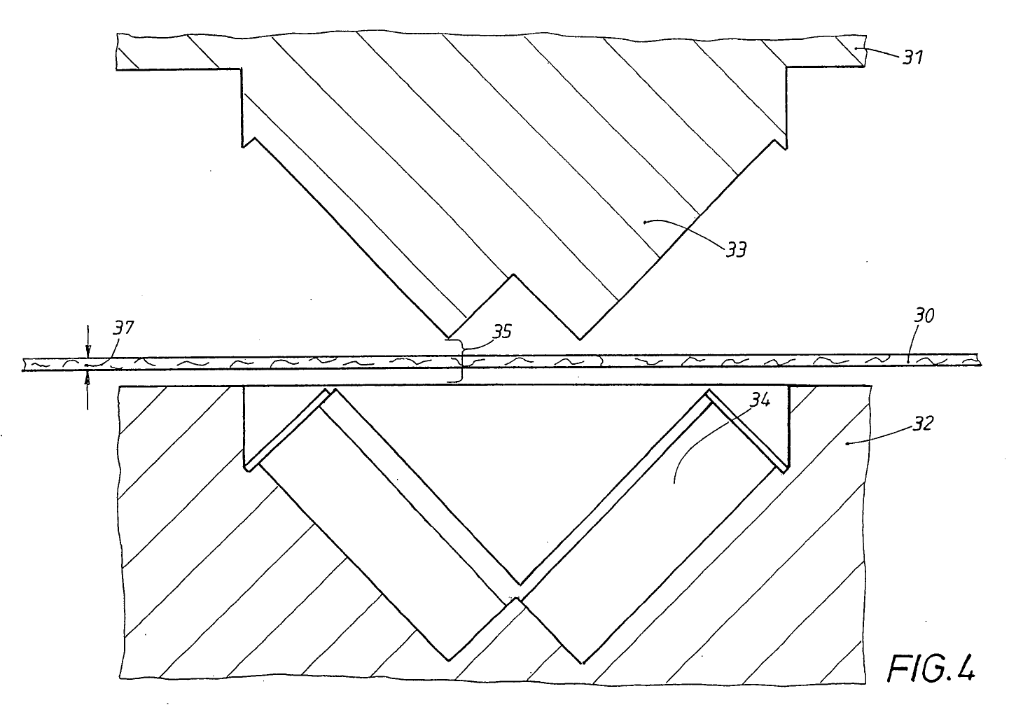

FIG. 4 shows a schematic, longitudinal-cross section through the two dies of a press used to produce the molded article shown in FIGS. 2 and 3, in a condition where the dies are a certain distance away from each other and a flat textile product has been introduced into the gap between them;

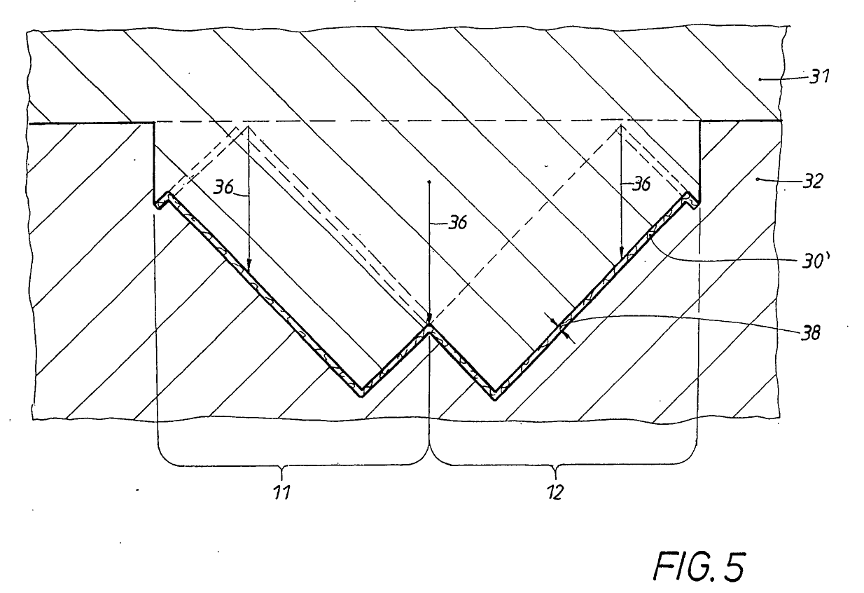

FIG. 5 shows a view similar to that of FIG. 4, in which the press is in the closed position for the purpose of producing the molded article out of the flat textile product;

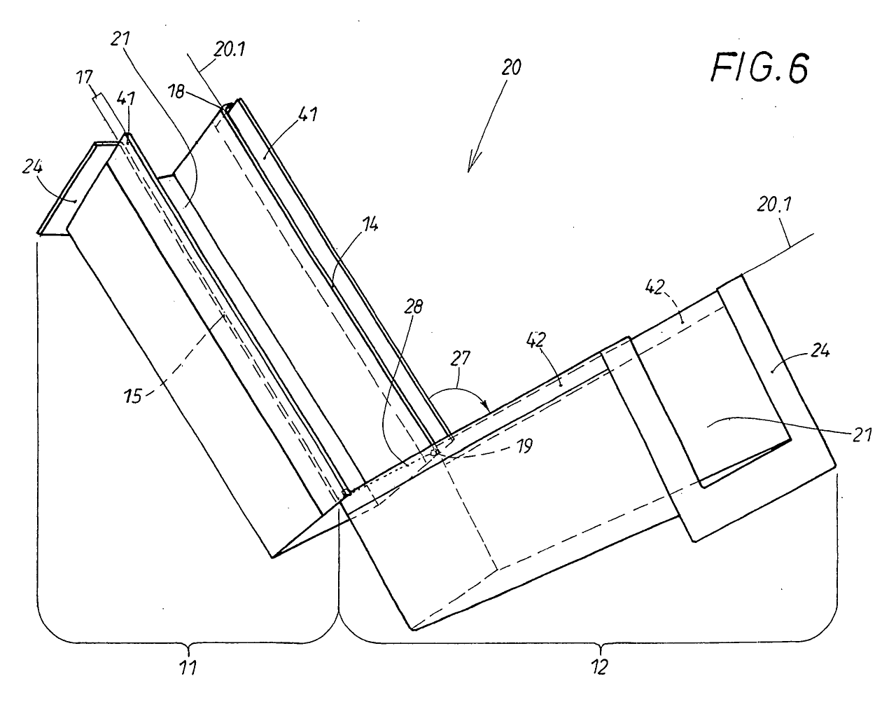

FIG. 6 shows a perspective view of a semi-finished product produced in the press of FIG. 5;

FIG. 7 shows a perspective view of the finished product obtained from the semi-finished product of FIG. 6, namely, of the molded article already shown in FIGS. 2 and 3;

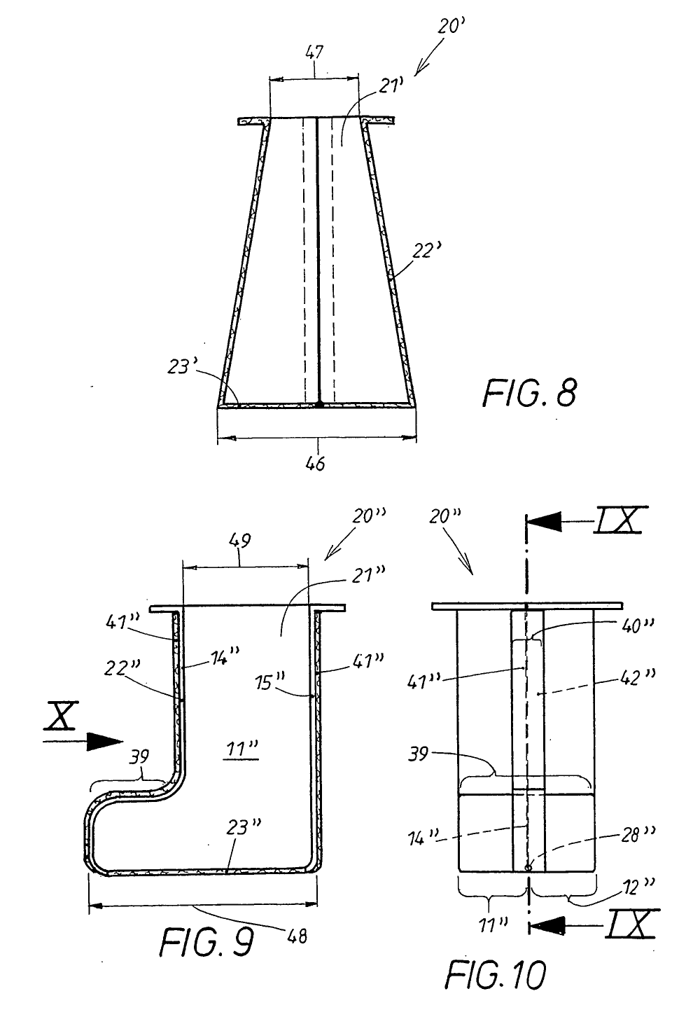

FIGS. 8 and 9 show corresponding longitudinal cross sections through alternative embodiments of a finished inventive molded article, where the cross-sectional line for FIG. 9 is indicated by line IX-IX in FIG. 10; and

FIG. 10 shows a side view of the third exemplary embodiment shown in FIG. 9, looking in the direction of the arrow X of FIG. 9.

FIG. 10 shows a longitudinal cross section of a part of a vehicle body 10, which is provided with a cup-like recess 13. A shell-shaped molded article 20, which consists of a flat textile product 30 according to FIG. 4, is to be introduced into this recess 13. This flat textile product 30 can be a piece of nonwoven material or of needled felt and initially is in the form of a flat web. The nonwoven or needled felt material is treated with a binder. The shell-shaped molded article 20 has an opening 21, which is bounded by a side wall 22. With respect to the working position shown in FIG. 1, the opening 21 is located at the outer end 25 of the molded article 20 and is provided there with a flange 24, which extends-all the way around the edge. The bottom of the shell thus determines the inner end 26 of the molded article 20. In the inserted position of FIG. 1, the edge flange 24 rests on the upper surface of the vehicle body 10, which surrounds the cup-shaped recess 13. The bottom of the shell can come to rest on the bottom 16 of the cup-like recess 13.

The molded article 20 is provided with two parting lines 14, 15, which extend along two opposing flat areas of the shell wall 22. As FIG. 1 shows, the parting lines 14, 15 proceed from the opening 21. This is also where the outer end 18 of the joint is located. In the present case, the parting lines 14, 15 extend over the entire depth 29 of the molded article 20, and the inner end 19 of the joint, as can be seen in FIG. 1, is located in the area of the bottom 23. The parting lines 14, 15 also pass through the molded flange 24.

The parting lines 14, 15 divide the molded article 20 into two segments 11, 12, shown in FIG. 6, which can be folded toward each other in the direction of the motion arrow 27 of FIG. 6. The bending line 28, illustrated in dotted line in FIGS. 3 and 6, extends between the inner joint ends 19 of the two parting lines 14, 15. This bending line functions now as an axis around which the segments can be folded. FIG. 6 shows the two molded segments 11, 12 in their folded-out position, indicated by the auxiliary lines 20.1, and the fold-out angle between them. FIG. 7 shows the folded-in position of the two molded segments. The parting lines 14, 15 are closed in FIG. 7. The folded-in position is illustrated in FIG. 7 by the auxiliary lines 20.2.

The molded article 20 is produced in a special way, which is explained in greater detail on the basis of FIGS. 4 and 5. Here are shown the heatable or coolable upper and lower dies 31, 32 of a press, in which the male profile 33 for the one molded segment 11 and the female profile 34 for the other molded segment 12 are formed on and recessed into their respective dies in a position characterizing the previously mentioned folded-open position 20.1. FIG. 4 shows the gap between the two dies 31, 32, moved toward each other. The previously mentioned flat textile product 30 is placed in the gap area 35, and then the two dies 31, 32 are pressed together. This is shown in FIG. 5. The originally flat product is thus deep-drawn to the extent indicated by the arrows 36 and assumes the material form 30′ for the two molded segments 11, 12, the flat textile product being molded into the final shape under the effect of pressure. The deep-drawing distance 36 is considerably smaller than the given shell depth 29 of the finished molded article 20 of FIG. 1. The textile material 30′ is therefore subjected to less stress than would be necessary if the desired shell depth 29 were to be produced according to the state of the art. As FIG. 4 shows, the thickness 37 of the layer can therefore be relatively small, and this means in turn that the input weight of the nonwoven material or needled felt 30 will be correspondingly reduced. The wall thickness 38 of the molded material 30′ of FIG. 5 is still sufficiently large, however, ever at its smallest point. After the flat textile product has been press-molded, the intermediate product shown in FIG. 6 is obtained, namely, the molded segments 11, 12 in their folded-out position 20.1.

The desired molded article 20 is obtained by folding in the material 27 of the two molded segments 11, 12 toward each other as shown in FIG. 6. The previously described folded-in position 10.2 of FIG. 7 is thus obtained. The treated textile material 30′ forms overlaps 40 in the area of the two parting lines 14, 15. This is illustrated in greater detail in FIG. 3a. At the edge 43 of the one molded segment 11, which defines the parting line 14 here, there is a flange 41, which is raised beyond the outside surface of the shell wall 22. A recessed, flattened area 42 at the edge 44 of the adjacent segment 12 cooperates with the flange 41. In the folded-in position of FIG. 3a, therefore, no sound bridges are formed in the area of the joints 14, 15 either. As previously mentioned, the parting lines 14, 15 also pass through the flange 24 extending around the edge of the shell opening 21. To obtain a satisfactory overlap in the area of these edge flanges 24, the parting line of the part of the flange 24 belonging to the first molded segment 11 is set back from the longitudinal edge of the joint-side flange 41 by a distance designated 17, as FIG. 6 illustrates.

Because the finished molded article 20 is inserted into the recess 13 of the vehicle body 10 according to FIG. 1, this alone guarantees that the two molded segments 11, 12 will remain in the folded-in position 10.2. To support this, it would be possible to apply binders, e.g., adhesives, to the area of the overlaps 40 or of the abutting parting lines 14, 15. As can be derived from FIGS. 3 and 6, the flanges 41 for both parting lines 14, 15 are on the same molded segment 11. The same is also true for the flattened areas 42, both of which are located on the second molded segment 12. In the present case, the two parting lines 14, 15 are aligned with each other, as can be seen in FIG. 3. In this case, the previously mentioned bending line 28 is very short. It would also be possible, of course, if necessary, to offset these parting lines 14, 15 from each other. In the latter case, the bending line 28 will then be longer and will run across the shell bottom 23 at an angle. The parting lines 14, 15 do not need to be straight lines or to be perpendicular to the shell bottom 23; they can have any desired profile and can be at any angle to the shell bottom 23.

The inventive molded article can, if necessary, have other 3-dimensional forms, which can be easily produced by fabricating the molded segments 11, 12 in their folded-open position 20.1. A second exemplary embodiment is shown in FIG. 8, where the same reference numbers as those used for the first exemplary embodiment are used again to name the corresponding parts. To differentiate the two sets of parts, however, the numbers of the second embodiment are given an apostrophe (′). There is no need to discuss anything but the differences.

In the case of the molded article 20′ of FIG. 8, the bottom 23′ of the shell has a width 46, which is much larger than the width 47 of the associated opening 21 of the shell. The side shell walls 22′ extend at an angle, expanding toward the bottom 23′ of the shell.

FIGS. 9 and 10 show a third exemplary embodiment of a molded article 20″ according to the invention. Here, too, it is necessary to discuss only the differences. The corresponding components are designated by the same reference numbers as those of the first exemplary embodiment, except that a double apostrophe (″) is added to identify them.

In this case, too, the bottom 23″ of the shell has a width 48 which is greater than the width 49 of the opening 21″ of the shell. This differences in width is accomplished in the case of the molded article 20″ by providing one of the side walls 32″ of the shell with a bulged-out area 39. With a molded article 20″ of this type, it is possible to fill correspondingly profiled, bulged-out recesses 13 in the body 10 of the vehicle. Of course, such molded articles 20-20″ can also be used as containers, independently of the vehicle body 10.

In the case the molded article 20″ of FIGS. 9 and 10, there are again overlaps 40″ in the area of the parting lines 14″, 15″. These overlaps 40″ consist, in a similar manner, of flanges 41″ and flattened areas 42″. In the case of molded article 20″, the parting lines 14″ and 15″ run through the bulged-out area 39 and thus divide the shape into the analogous molded segments 11″, 12″, which can be folded toward each other. In this case, too, the parting lines 14″, 15″ run along the entire length of the side walls 22″. As a result, the bending line 28″, which functions as the folding axis, is located in the bottom 23″ of the shell and connects the two inner ends of the parting lines 14″, 15″.

### LIST OF REFERENCE NUMBERS

10 vehicle body (FIG. 1)
11 first molded segment of 20 (FIG. 6)
11″ lift first molded segment of 20″ (FIGS. 9, 10)
12 second molded segment of 20 (FIG. 6)
12″ second molded segment of 20′ (FIGS. 8, 9)
13 cup-shaped recess in 10 (FIG. 1)
14 first parting line in 20 (FIGS. 1-3)
14″ first parting line of 20″ (FIGS. 9, 10)
15 second parting line of 20 (FIGS. 1-3)
15″ second parting line of 20″ (FIGS. 9, 10)
16 bottom of cup 13
17 offset for 24 on 11 (FIG. 6)
18 outer end of 14, 15 (FIG. 1)
19 inner end of 14, 15 (FIG. 1)
20 molded article (FIGS. 1-7)
20′ first alternative to 20 (FIG. 8)
20″ second alternative to 20 (FIGS. 9, 10)
20.1 folded-out position of 11, 12 (FIG. 6)
20.2 folded-in position of 11, 12 (FIG. 7)
21 shell opening of 20
21′ shell opening of 20′
21″ shell opening of 20″
22 side shell wall of 20
22′ side shell wall of 20′
22″ side shell wall of 20″
23 shell bottom of 20
23′ shell bottom of 20′
23″ shell bottom of 20″
24 edge flange on 22 (FIG. 1)
25 outer end of 20 (FIG. 2)
26 inner end of 20 (FIG. 2)
27 arrow of folding movement of 11, 12 (FIG. 6)
28 bending line between 14, 15 (FIG. 3)
28″ bending line between 14″, 15″ (FIG. 10)
29 shell depth of 20 (FIG. 1)
30 flat textile product, nonwoven (FIG. 4)
30′ molded material of 30 (FIG. 5)
31 upper die of the press (FIGS. 4, 5)
32 bottom die of the press (FIGS. 4, 5)
33 male profile of 11, 12 (FIG. 4)
34 female profile of 11, 12 (FIG. 4)
35 gap between 31, 32 (FIG. 4)
36 deep-drawing distance of 30 for 30′ (FIG. 5)
37 layer thickness of 30 (FIG. 4)
38 minimum wall thickness of 30′ (FIG. 5)
39 bulged-out area of 22″ (FIG. 9)
40 overlap of 22 (FIGS. 2, 3, 3a, 7)
40′ overlap of 22″ (FIG. 10)
41 projecting flange on 22 for 11 (FIGS. 3, 6)
41″ flange on 22″ (FIGS. 9, 10)
42 recessed flattened area on 22 (FIGS. 3, 6)
42″ recessed flattened area on 22″ (FIGS. 9, 10)
43 edge of 11 at 14 (FIG. 3a)
44 edge of 12 at 14 (FIG. 3)
45 outer surface of 22 (FIG. 3a)
46 width of 23′ (FIG. 8)
47 open width of 21′ (FIG. 8)
48 width of 23″ (FIG. 9)
49 open width of 21″ (FIG. 9)

1. Cup-shaped molded article (cup) produced from a flat textile product (30) in the form of nonwoven material or needled felt,
where the cup (20) is produced in a molding press (31, 32) and is used to fit out motor vehicles, wherein
each of the two opposite side walls (22) of the cup has a parting line (14, 15), which starts (18) from the opening (21) of the cup and proceeds (19) all the way to the bottom (23) of the cup; in that
the parting lines (14, 15) divide the cup (20) longitudinally into two cup segments (11, 12), which are connected to each other across the bottom (23) of the cup; in that
the inner ends (19) of the two parting lines (14, 15) define between them a bending line (28) in the bottom (23) of the cup;
which bending line functions as a fold axis for the bottom (23), so that the two cup segments (11, 12) can be converted from a folded-out position (20.1) to a folded-in position (20.2); in that
the two cup segments (11, 12), although molded from the flat textile product (30) in two separate areas, are produced simultaneously, adjacent to each other, in their folded-open position (20.1) between the two halves of the press, where the edges (43, 44) of the two parting lines (14, 15) face one of the halves of the press; and in that
in the folded-in position (20.2), the parting lines (14, 15) butt up against each other, and the closed cup segments (11, 12) form the finished cup (20).

2. Cup (20) according to claim 1, wherein, in the folded-in position (20.2), the cup segments (11, 12) are attached to each other along their closed parting lines (14, 15).

3. Cup (20) according to claim 1, wherein overlaps (40) of the flat textile product (30) are located at the parting lines (14, 15) and engage with each other when the two cup segments (11, 12) are in the folded-in position (20.2).

4. Cup (20) according to claim 3, wherein the overlaps consist of a lowered flattened area (42) and a projecting flange (41), where the flange (41) is at the edge (43) of the parting line (14, 15) of the one cup segment (11), whereas the flattened area (42) is at the edge (44) of the adjacent cup segment (12).

5. Cup (20) according to claim 1, wherein, in the folded-in position, the edges (43, 44) of the parting lines (14, 15) and/or the overlaps (40) are held permanently together by a binder.

6. Cup (20) according to claim 1, wherein, from the perspective of the cup opening (21′, 21″), the side wall (22′, 22″) is undercut at least in a certain area; and in that
the undercut side walls (22′, 22″) lead to a bottom (23′, 23″), which is wider, at least in a certain area, than the open width (47, 49) of the cup opening (21′, 21″).

7. Cup (20) according to claim 6, wherein the undercut of the side wall (22″) is produced by a bulged-out area (39) of the cup (20).

8. Cup (20) according to claim 1, wherein the opening (21, 21′, 21″) of the cup is surrounded by a flange (24), which is at an angle to the side wall (22, 22′, 22″) of the cup.
